(19) United States
(12) Patent Application Publication
(10) Pub. No.: US 2014/0267889 A1
(43) Pub. Date: Sep. 18, 2014

(54) CAMERA LENS BUTTON SYSTEMS AND METHODS

(71) Applicants: James W. McGowan, Flemington, NJ (US); Tom Janiszewski, Andover, NJ (US)

(72) Inventors: James W. McGowan, Flemington, NJ (US); Tom Janiszewski, Andover, NJ (US)

(73) Assignee: Alcatel-Lucent USA Inc., Murray Hill, NJ (US)

(21) Appl. No.: 13/800,417

(22) Filed: Mar. 13, 2013

(51) Int. Cl. H04N 5/232

(52) U.S. Cl. CPC H04N 5/232
USPC 348/373

(57) ABSTRACT

A system and method for providing an input button includes receiving at least one image frame captured through a camera lens and analyzing the at least one image frame at a processor to determine if the at least one image frame is indicative of a button press. If the at least one image frame is indicative of a button press, a trigger module generates a trigger event that causes an application to perform an action.

### FIELD OF THE INVENTION

The present invention relates to user input controls.

### BACKGROUND OF THE INVENTION

Many electronic devices, e.g. cellular telephones, computers, tablets, laptop computers and the like, often have at least one camera lens that allows the electronic device, through an appropriate photography and/or video software platform, to capture image frames such as digital photographs and/or streams of video frames.

### SUMMARY

According to an embodiment, a system for providing an input button includes a camera lens and at least one processor connected to the camera lens. The at least one processor is adapted to execute an imaging platform for detecting images through the camera lens. The system also includes a trigger module in communication with the imaging platform. The trigger module is adapted to be executed by the at least one processor to generate a trigger event upon a determination that at least one image frame captured through the camera lens is indicative of a button press. An application may be in communication with the trigger module and may perform an action in response to the trigger event.

According to an embodiment, the trigger module may determine that the at least one image frame is indicative of a button press if an average pixel intensity of a plurality of pixels of the image frame is below a threshold value.

According to an embodiment, the plurality of pixels may be a subset of all of the pixels of the image frame.

According to an embodiment, the subset of pixels may include pixels dispersed along an edge of the image frame.

According to an embodiment, the trigger module may analyze a stream of image frames to determine if the stream of image frames is indicative of a button press and may generate the trigger event upon a determination that the stream of image frames is indicative of the button press.

According to an embodiment, the trigger module may compare an average pixel intensity of a plurality of pixels of each image frame of the stream of image frames to a threshold value and may generate the trigger event if the average pixel intensity for each image frame is below the threshold value for a predefined number of consecutive image frames.

According to an embodiment, the trigger module may be adapted to determine if consecutive image frames of the stream of image frames are getting progressively darker for a predefined number of image frames.

According to an embodiment, the trigger module may be adapted to compute a sum or average of a number of pixels of the image frame with intensities that are below a first threshold and to compare the sum or average of the number of pixels to a second threshold. The trigger module may generate the trigger event if the sum or average of the number of pixels exceeds the second threshold.

According to an embodiment, a computerized method includes receiving at least one image frame captured through a camera lens and analyzing the at least one image frame to determine if the at least one image frame is indicative of a button press. The computerized method also includes generating a trigger event if the at least one image frame is indicative of the button press. An application may perform an action in response to the trigger event.

According to an embodiment, analyzing the at least one image frame may include comparing an average pixel intensity of a plurality of pixels of the image frame to a threshold value.

According to an embodiment, the trigger event may be generated if the average pixel intensity is below the threshold value.

According to an embodiment, the plurality of pixels may be a subset of all of the pixels of the image frame.

According to an embodiment, the subset may include pixels dispersed along an edge of the image frame.

According to an embodiment, analyzing the at least one image frame may include analyzing a stream of image frames to determine if the stream of image frames is indicative of a button press.

According to an embodiment, analyzing the stream of image frames may include comparing an average pixel intensity of a plurality of pixels of each image frame of the stream of image frames to a threshold value. The trigger event may be generated if the average pixel intensity for each image frame is below the threshold value for a predefined number of consecutive image frames.

According to an embodiment, analyzing the stream of image frames may include determining if the consecutive image frames of the stream of image frames are getting progressively darker for a predefined number of image frames.

According to an embodiment, analyzing the at least one image frame may include computing a sum or average of a number of pixels of the image frame with intensities that are below a first threshold and comparing the sum or average of the number of pixels to a second threshold. The trigger event may be generated if the sum or average of the number of pixels exceeds the second threshold.

According to an embodiment, a non-transitory, tangible computer-readable medium storing instructions adapted to be executed by a computer processor to perform a method may comprise the steps of receiving at least one image frame captured through a camera lens and analyzing the at least one image frame to determine if the at least one image frame is indicative of a button press. The method may also comprise the step of generating a trigger event if the at least one image frame is indicative of the button press. An application may perform an action in response to the trigger event.

According to an embodiment, the method may further comprise analyzing the at least one image frame by comparing an average pixel intensity of a plurality of pixels of the image frame to a threshold value.

According to an embodiment, the method may further comprise generating the trigger event if the average pixel intensity is below the threshold value.

According to an embodiment, the plurality of pixels may be a subset of all of the pixels of the image frame.

According to an embodiment, the subset may include pixels dispersed along an edge of the image frame.

According to an embodiment, analyzing the at least one image frame may include analyzing a stream of image frames to determine if the stream of image frames is indicative of a button press.

According to an embodiment, analyzing the stream of image frames may include comparing an average pixel intensity of a plurality of pixels of each image frame of the stream of image frames to a threshold value. The trigger event may be generated if the average pixel intensity for each image frame is below the threshold value for a predefined number of consecutive image frames.

According to an embodiment, analyzing the stream of image frames may include determining if the consecutive image frames of the stream of image frames are getting progressively darker for a predefined number of image frames.

According to an embodiment, analyzing the at least one image frame may include computing a sum or average of a number of pixels of the image frame with intensities that are below a first threshold and comparing the sum or average of the number of pixels to a second threshold. The trigger event may be generated if the sum or average of the number of pixels exceeds the second threshold.

These and other embodiments will become apparent in light of the following detailed description herein, with reference to the accompanying drawings.

### BRIEF DESCRIPTION OF THE DRAWINGS

FIG. 1 is a schematic diagram of a system according to an embodiment;

FIG. 2 is a flow diagram of an embodiment for providing a camera lens button in the system of FIG. 1;

FIG. 3 is a flow diagram of an embodiment for providing a camera lens button in the system of FIG. 1;

FIG. 4 is a flow diagram of an embodiment for providing a camera lens button in the system of FIG. 1; and

FIG. 5 is a flow diagram of an embodiment for providing a camera lens button in the system of FIG. 1.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

Referring to FIG. 1, a computerized system 10 for adapting a camera lens 12 of an electronic device (e.g. a cellular telephone, a computer, a tablet, a laptop computer or any similar device) to provide a user input button is shown. The system 10 includes the camera lens 12, a processor 14 and memory 16. The system may also include a display 18, a communication interface unit 20 a speaker 22, an input output controller 24 and/or other similar electronic components, as will be discussed in greater detail below.

The processor 14 is adapted to execute an imaging platform 26 and a trigger module 28. The imaging module 26 allows the camera lens 12 to capture image frames such as digital photographs and/or video frames to be stored in memory 16, processed by the processor 14 and/or used for some other suitable purpose. The imaging platform 26 may be any suitable platform for use in electronic devices, as should be understood by those skilled in the art. For example, in an embodiment, camera lens 12 may be provided on a smart-phone (not shown) and the imaging platform 26 may be the standard imaging platform programmed as part of the smart-phone (not shown) for capturing images, video, scanning barcodes or the like. The trigger module 28 is in communication with the imaging platform 26 and is adapted to evaluate image frames captured through the camera lens 12 and to trigger events based on said image frames.

The computerized system 10 has the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein. For example, as discussed above, the computerized system 10 may include processor 14 and memory 16, which may include system memory, including random access memory (RAM) and read-only memory (ROM). The computerized system 10 may be connected to the World Wide Web and/or to one or more external devices through the communication interface unit 20. For example, the communication interface unit 20 may include a network interface, including wired and wireless network interfaces, a Bluetooth enabled interface or other similar communication interfaces. All of these latter elements are in communication with the processor 14 to facilitate the operation of the computerized system 10 as discussed below. Suitable computer program code may be provided for executing numerous functions, including those discussed below in connection with the imaging platform 26 and trigger module 28. The computer program code may also include program elements such as an operating system, a database management system and “device drivers” that allow the processor 14 to interface with computer peripheral devices (e.g., the display 18, a keyboard, a computer mouse, etc.) via the input/output controller 24.

The processor 14 may include one or more conventional microprocessors and one or more supplementary co-processors such as math co-processors or the like. The processor 14 may be in communication with the communication interface unit 20, through which the processor 14 may communicate with other networks and/or devices such as servers, other processors, computers, cellular telephones, tablets, projectors and the like. The communication interface unit 20 may include multiple communication channels for simultaneous communication with, for example, other processors, servers, computers, cellular telephones, tablets, projectors or the like. Devices in communication with each other need not be continually transmitting to each other. On the contrary, such devices need transmit to each other as necessary, may actually refrain from exchanging data most of the time, and may require several steps to be performed to establish a communication link between the devices.

The processor 14 is in communication with the memory 16, which may comprise an appropriate combination of magnetic, optical and/or semiconductor memory, and may include, for example, RAM, ROM, flash drive, an optical disc such as a compact disc and/or a hard disk or drive. The processor 14 and the memory 16 each may be, for example, located entirely within a single computer or other device; or connected to each other by a communication medium, such as a USB port, serial port cable, a coaxial cable, an Ethernet type cable, a telephone line, a radio frequency transceiver or other similar wireless or wired medium or combination of the foregoing. For example, the processor 14 may be connected to memory 16 via the communication interface unit 20.

The memory 16 may store, for example, one or more databases and/or other information required by the imaging platform 26, the trigger module 28, an operating system for the computerized system 10, and/or one or more other programs (e.g., computer program code and/or a computer program product) adapted to direct the processor 14 to provide a user input button through the camera lens 12 according to the various embodiments discussed herein. The operating system, the imaging platform 26, the trigger module 28 and/or other programs may be stored, for example, in a compressed, an uncompiled and/or an encrypted format, and may include computer program code. The instructions of the computer program code may be read into a main memory of the processor 14 from the memory 16 or a computer-readable medium other than the memory 16. While execution of sequences of instructions in the program causes the processor 14 to perform the process steps described herein, hard-wired circuitry may be used in place of, or in combination with, software instructions for implementation of the processes of the present invention. Thus, embodiments of the present invention are not limited to any specific combination of hardware and software.

The programs discussed herein may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such providing a user input button through the camera lens 12. In an embodiment, an application of executable code may be a compilation of many instructions, and may even be distributed over several different code partitions or segments, among different programs, and across several devices.

The term “computer-readable medium” as used herein refers to any medium that provides or participates in providing instructions to the processor 14 of the computerized system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 14 (or any other processor of a device described herein) for execution. For example, the instructions may initially be borne on a magnetic disk of a remote computer (not shown). The remote computer can load the instructions into its dynamic memory and send the instructions over an Ethernet connection, cable line, telephone line using a modem, wirelessly or over another suitable connection. A communications device local to a computing device (e.g., a server) can receive the data on the respective communications line and place the data on a system bus for the processor 14. The system bus carries the data to the main memory, from which the processor 14 retrieves and executes the instructions. The instructions received by main memory may optionally be stored in memory 16 either before or after execution by the processor 14. In addition, instructions may be received via a communication port as electrical, electromagnetic or optical signals, which are exemplary forms of wireless communications or data streams that carry various types of information.

In operation, the computerized system 10 adapts the camera lens 12 of the electronic device (e.g. a cellular telephone, a computer, a tablet, a laptop computer or any similar device) to provide a user input button by detecting when a user covers or blocks at least a portion of the camera lens 12 (e.g. with a finger or the like) and triggering an event in response thereto. The event trigger may be received by an application, as will be discussed in greater detail below, which then performs some action in response to the trigger. For example, in an embodiment, the application may turn the camera off, end a videoconference, flip a virtual slide presentation to the next slide or perform any similar action within the functionality provided by the application.

Referring to FIG. 2, in an embodiment, operation of the computerized system 10, shown in FIG. 1, is initiated at 30. The processor 14, shown in FIG. 1, begins executing the imaging platform 26, shown in FIG. 1, so that image frames (e.g. video frames) may be captured through the camera lens 12, shown in FIG. 1, and made available to the processor 14, shown in FIG. 1, for processing.

Digital cameras provided on electronic devices, such as that provided by the camera lens 12 in combination with the imaging platform 26, both shown in FIG. 1, use photosensitive electronic image sensors, consisting of a large number of single sensor elements, often called pixels, which are typically arranged in an array. Each sensor elements or pixel records a measured intensity level of light. For example, in many digital cameras, pixel intensity may be a value between 0 and 255, where 0 is indicative of a dark pixel reading and 255 is indicative of a bright pixel reading. In most digital cameras, the sensor array is covered with a patterned color filter mosaic having red, green, and blue regions so that each sensor element can record the intensity of a single primary color of light. The digital camera then interpolates the color information of neighboring sensor elements to create the final image frame. Thus, the sensor elements or pixels each record the intensity of one channel (i.e. only red, or green, or blue) of the final color image frame.

At 32, the trigger module 28, shown in FIG. 1, grabs an image frame captured by the imaging platform 26, shown in FIG. 1, through the camera lens 12, shown in FIG. 1. The trigger module 28, shown in FIG. 1, then computes an energy level M for the captured image frame at 34. In an embodiment, the energy level M may be the average pixel value across the image frame (i.e. the average of the intensities recorded by the pixels for the image frame). The exact computation may depend upon the image representation. For example, if the digital camera includes the red, green and blue filter mosaic discussed above, the energy level M may simply be the average of all samples from the red, green and blue channels. Thus, in the exemplary embodiment discussed above, the energy level M may be some value from 0 to 255.

As should be understood by those skilled in the art, the embodiments described herein may be equally applicable to image frames captured in image formats other than the red, green and blue filter format discussed above. For example, for image frames captured in the YUV format, an average of the pixels values detecting Y samples may be sufficient for providing the energy level M. Alternatively, to take into account the U and/or V channels in addition to the Y channel, the energy level M may be computed by taking an average of the U and/or V channels independently, normalizing the channel so that zero represents the neutral color value, and then averaging the U, V and Y channels collectively (i.e. (avg(Y)+avg(U)+avg(V))/3). These embodiments may be equally applicable to other image formats as should be understood by those skilled in the art.

Once the energy level M has been computed at 34, the trigger module 28, shown in FIG. 1, compares the energy level M to a threshold T at 36. If the energy level M is below the threshold T, the trigger module 28, shown in FIG. 1, generates a trigger event at 38 signifying a “button press” event. Alternatively, if the energy level M is not below the threshold T, the trigger module 28, shown in FIG. 1, does not generate the trigger event. Instead, the trigger module 28, shown in FIG. 1, returns to 32 and grabs another image frame captured by the imaging platform 26, shown in FIG. 1, through the camera lens 12, shown in FIG. 1. The trigger module 28, shown in FIG. 1, then computes and compares the energy level M for the new image frame, as discussed above, to determine if a trigger event should be generated based on the new image frame. Continuing with the exemplary embodiment discussed above, where pixel intensities are in the range of 0 to 255 with an image frame rate of 24 fps, the threshold T for triggering the trigger event may be approximately 10. Thus, if the energy level M (i.e. the average pixel value across the image frame) is less than 10, the trigger module will generate the trigger event.

When the trigger module 28, shown in FIG. 1, generates the trigger event at 38, an application then receives the event trigger at 40. The application may receive the event trigger at 40 in a variety of ways as should be understood by those skilled in the art. For example, the application may be monitoring the trigger module 28, shown in FIG. 1, for the event trigger or, alternatively, the trigger module 28, shown in FIG. 1, may transmit the event trigger to the application. In an embodiment, the application may be running on the electronic device itself, e.g. the application may be being executed by the processor 14, shown in FIG. 1, or by some other processor of the electronic device, thereby allowing detection and/or transmission of the event trigger to occur entirely within the electronic device. In some embodiments, the application may be executing on another device that is external to the electronic device including the trigger module 28, shown in FIG. 1. In these embodiments, the detection and/or transmission of the event trigger may occur over the communication interface unit 20, shown in FIG. 1, as should be understood by those skilled in the art.

Once the application receives the event trigger at 40, the application performs an action in response to the event trigger at 42. The action performed by the application may be essentially any action within the functionality provided by the application. For example, the application may flip a virtual slide presentation to the next slide, begin and/or end a video presentation, shut off the digital camera of the electronic device, exit a video conference, turn off the computer or the electronic device, or any similar action.

Still referring to FIG. 2, in an embodiment, the trigger module 28, shown in FIG. 1, may only use a subset of the pixels when computing the energy level M at 34 to lower complexity. For example, the trigger module 28, shown in FIG. 1, may select every fourth pixel with at least twelve pixels dispersed on the edge of the image frame and may compute the average pixel value, as discussed above, using only the selected pixels. Dispersing the selected pixels over the image frame maintains a robustness of the system 10, shown in FIG. 1, while reducing computational complexity by reducing the total number of pixels used in the computation by the trigger module 28, shown in FIG. 1. Selecting pixels dispersed along the edge of the image frame adds further robustness to the system since it is unlikely that a passing object will blank the camera lens 12, shown in FIG. 1, from edge-to-edge unless the intention is to signal a “button press” event. Using the subset of pixels may also allow the system 10, shown in FIG. 1, to account for situations where light is allowed into the camera lens 12, shown in FIG. 1, from the side of the lens (e.g. due to camera/lens misalignment or where a user cannot adequately cover the lens from a one handed phone grip). For example, the subset may include only centrally located pixels or pixels weighted to a specific area or side of the image frame.

Referring to FIG. 3, in an embodiment, the energy level M of the image (e.g. video) being detected through the camera lens 12, shown in FIG. 1, must be below the threshold T for a predefined number of frames n before the event is triggered by the trigger module 28, shown in FIG. 1. In this embodiment, the operation of the computerized system 10, shown in FIG. 1, is initiated at 130. The processor 14, shown in FIG. 1, begins executing the imaging platform 26, shown in FIG. 1, so that image frames (e.g. video frames) may be captured through the camera lens 12, shown in FIG. 1, and made available to the processor 14, shown in FIG. 1, for processing. Upon initiation of the system 10, shown in FIG. 1, the trigger module 28, shown in FIG. 1, sets a frame count f to an initial value of zero at 144.

At 132, the trigger module 28, shown in FIG. 1, grabs an image frame captured by the imaging platform 26, shown in FIG. 1, through the camera lens 12, shown in FIG. 1, and then increases the frame count f by one increment at 146. At 134, the trigger module 28, shown in FIG. 1, computes the energy level M for the captured image frame in substantially the same manner discussed above in connection with step 34 of FIG. 2.

The trigger module 28, shown in FIG. 1, then compares the energy level M to the threshold T at 136. If the energy level M is not below the threshold T, the trigger module 28, shown in FIG. 1, does not generate the trigger event. Instead, the trigger module 28, shown in FIG. 1, returns to 144 and resets the frame count f to the initial value of zero. The trigger module 28, shown in FIG. 1, then grabs the next image frame captured by the imaging platform 26, shown in FIG. 1, through the camera lens 12, shown in FIG. 1, at 132, increase the frame count f by one increment at 146 and computes and compares the energy level M for the new image frame, as discussed above, to determine if the energy level M is below the threshold T.

If, however, the energy level M is below the threshold T at 136, the trigger module 28, shown in FIG. 1, then evaluates whether the frame count f has reached the predefined number of frames n at 148. If the frame count f has reached the predefined number of frames n, the trigger module 28, shown in FIG. 1, generates the trigger event at 138 signifying the “button press” event in substantially the same manner discussed above in connection with step 38 of FIG. 2. In an embodiment, the trigger module 28, shown in FIG. 1, may also generate a feedback signal indicative of the “button press” event occurring. The feedback signal may be, for example, an audible beep through the speaker 22, shown in FIG. 1, vibratory feedback or the like.

If the frame count f has not reached the predefined number of frames n at 148, the trigger module 28, shown in FIG. 1, returns to 132 to grab the next image frame, increases the frame count f by one increment at 146 and computes and compares the energy level M for the new image frame, as discussed above, to determine if the energy level M is below the threshold T for the predefined number of frames n. Thus, the trigger module 28, shown in FIG. 1, only generates the trigger event if the camera lens is blocked (as defined by the threshold T) for a preset length of time (as defined by the predefined number of frames n). Continuing with the exemplary embodiment discussed above, where pixel intensities are in the range of 0 to 255 with the image frame rate of 24 fps, the threshold T may be approximately 16 and the predefined number of frames may be approximately 10. Thus, if the energy level M (i.e. the average pixel value across the image frame) is less than 16 for at least 10 consecutive image frames, the trigger module will generate the trigger event.

Once the trigger module 28, shown in FIG. 1, generates the event trigger at 138, the application receives the event trigger at 140 and performs the action at 142 in substantially the same manner discussed above in connection with steps 40 and 42 of FIG. 2.

Referring to FIG. 4, in an embodiment, the trigger module 28, shown in FIG. 1, may only generate the event trigger if it determines that the image (e.g. video) provided by the camera lens 12, shown in FIG. 1, was getting progressively darker for the predefined number of frames n on at least a percentage of the pixels being evaluated. In this embodiment, the operation of the computerized system 10, shown in FIG. 1, is initiated at 230. The processor 14, shown in FIG. 1, begins executing the imaging platform 26, shown in FIG. 1, so that image frames (e.g. video frames) may be captured through the camera lens 12, shown in FIG. 1, and made available to the processor 14, shown in FIG. 1, for processing. Upon initiation of the system 10, shown in FIG. 1, the trigger module 28, shown in FIG. 1, sets the frame count f to the initial value of zero at 244.

At 232, the trigger module 28, shown in FIG. 1, grabs an image frame captured by the imaging platform 26, shown in FIG. 1, through the camera lens 12, shown in FIG. 1, and then increases the frame count f by one increment at 246. At 250, the trigger module 28, shown in FIG. 1, computes an energy level M_{f} for each pixel being evaluated from the captured image frame. For example, the energy level M_{f} for each pixel may simply be the intensity value of that pixel. At 252, the trigger module 28, shown in FIG. 1, compares the energy level M_{f} for each pixel to an energy level M_{f-1} for the same pixel, where the energy level M_{f-1} is the energy level computed at step 250 for the same pixel in the previous image frame of the video. Thus, the trigger module 28, shown in FIG. 1, determines if the energy level for each pixel being evaluated is getting progressively darker (i.e. the trigger module 28, shown in FIG. 1, determines if M_{f} is less than M_{f-1} for each pixel being evaluated). If the energy levels for a predefined percentage P of the pixels being evaluated are getting progressively darker at 252, the trigger module 28, shown in FIG. 1, proceeds to step 248 and evaluates whether or not the frame count f has reached the predefined number of frames n at 248. If, however, the trigger module 28, shown in FIG. 1, determines that the energy levels for the percentage P of the pixels being evaluated are not getting progressively darker at 252, the trigger module 28, shown in FIG. 1, returns to 244 and resets the frame count f to the initial value of zero. The trigger module 28, shown in FIG. 1, then grabs the next image frame captured by the imaging platform 26, shown in FIG. 1, through the camera lens 12, shown in FIG. 1, at 232, increase the frame count f by one increment at 246 and computes and compares the energy levels M_{f} for the new image frame, as discussed above.

If the frame count f has reached the predefined number of frames n at 248, the trigger module 28, shown in FIG. 1, generates the trigger event at 238 signifying the “button press” event in substantially the same manner discussed above in connection with step 38 of FIG. 2 and step 138 of FIG. 3. In this embodiment, the predefined number of frames n should be selected to be longer than a decay time of the pixels' outputs given a fixed number of frames for the percentage of pixels P. For example, continuing with the exemplary embodiment discussed above, where pixel intensities are in the range of 0 to 255 with the image frame rate of 24 fps, the percentage P of pixels having energy levels below those of the previous image frame may be approximately 70% and the predefined number of frames may be approximately 4. Thus, if the energy levels M_{f} are less than the energy levels M_{f-1} for at least 70% of the pixels for 4 consecutive image frames, the trigger module will generate the trigger event. As with the embodiment shown in FIG. 3, the trigger module 28, shown in FIG. 1, may also generate the feedback signal indicative of the “button press” event occurring. The feedback signal may be, for example, the audible beep through the speaker 22, shown in FIG. 1, vibratory feedback or the like. If the frame count f has not reached the predefined number of frames n at 248, the trigger module 28, shown in FIG. 1, returns to 232 to grab the next image frame, increases the frame count f by one increment at 246 and computes and compares the energy levels M_{f} for the new image frame, as discussed above. Thus, the trigger module 28, shown in FIG. 1, only generates the trigger event if the camera lens is gets progressively darker for at least the percentage P of the pixels for a preset length of time (as defined by the predefined number of frames n). Accordingly, in this embodiment, the trigger module 28, shown in FIG. 1, may distinguish an intended event trigger where the camera lens 12, shown in FIG. 1, becomes progressively blocked (e.g. as the user places a finger over the camera lens 12, shown in FIG. 1) from an unintentional event that might otherwise result in an event trigger such as a turning off lights or the like.

Once the trigger module 28, shown in FIG. 1, generates the event trigger at 238, the application receives the event trigger at 240 and performs the action at 242 in substantially the same manner discussed above in connection with steps 40 and 42 of FIG. 2 and steps 140 and 142 of FIG. 3.

Referring to FIG. 5, in an embodiment, operation of the computerized system 10, shown in FIG. 1, is initiated at 330. The processor 14, shown in FIG. 1, begins executing the imaging platform 26, shown in FIG. 1, so that image frames (e.g. video frames) may be captured through the camera lens 12, shown in FIG. 1, and made available to the processor 14, shown in FIG. 1, for processing. At 332, the trigger module 28, shown in FIG. 1, grabs an image frame captured by the imaging platform 26, shown in FIG. 1, through the camera lens 12, shown in FIG. 1. At 350, the trigger module 28, shown in FIG. 1, computes an energy level M_{f} for each pixel being evaluated from the captured image frame. For example, as discussed above, the energy level M_{f} for each pixel may simply be the intensity value of that pixel. At 354, the trigger module 28, shown in FIG. 1, computes a sum S of the number of pixels where M_{f} is below a first threshold T1. At 356, the trigger module 28, shown in FIG. 1, determines whether the sum S is greater than a second threshold T2. If the sum S is greater than the second threshold T2, the trigger module 28, shown in FIG. 1, generates the trigger event at 338 signifying the “button press” event. Alternatively, if the sum S is not greater than the second threshold T2, the trigger module 28, shown in FIG. 1, does not generate the trigger event. Instead, the trigger module 28, shown in FIG. 1, returns to 332 and grabs the next image frame captured by the imaging platform 26, shown in FIG. 1, through the camera lens 12, shown in FIG. 1. The trigger module 28, shown in FIG. 1, then computes and compares the energy levels M_{f} and sum S for the new image frame in the same manner discussed above. Continuing with the exemplary embodiment discussed above, where pixel intensities are in the range of 0 to 255 with the image frame rate of 24 fps, the first threshold T1 may be approximately 16 and the second threshold T2 may be set to be approximately 80% of the image (e.g. for a 240×320 pixel image, T2 may be approximately 61,440). Thus, if the energy level M_{f} for at least 80% of the pixels is less than 16, the trigger module will generate the trigger event. This embodiment advantageously provides a particularly low complexity evaluation for determining the “button press” event.

Once the trigger module 28, shown in FIG. 1, generates the event trigger at 338, the application receives the event trigger at 340 and performs the action at 342 in substantially the same manner discussed above in connection with steps 40 and 42 of FIG. 2.

Still referring to FIG. 5, in an embodiment, rather than computing the sum S at 354 and comparing the sum S to the second threshold T2 at 356, the trigger module 28, shown in FIG. 1, may instead compute an average A of the number of pixels with energy levels M_{f} below the first threshold T1 at 354. The trigger module 28, shown in FIG. 1, then compares the average A to the second threshold T2 at 356 to determine if the trigger event should be generated at 338. For example, continuing with the exemplary embodiment discussed above, where pixel intensities are in the range of 0 to 255 with the image frame rate of 24 fps, the first threshold T1 may be approximately 16 and the second threshold T2 may 0.8. Thus, if the energy level M_{f} for at least 80% of the pixels is less than 16, the trigger module will generate the trigger event.

Although the embodiments shown in FIGS. 2-5 have been described separately for clarity, it should be understood by those skilled in the art that the embodiments, as well as the various features thereof, may be combined into a single embodiment to provide the computerized system 10, shown in FIG. 1, and described herein. Additionally, it should be understood by those skilled in the art that the exemplary thresholds, energy levels, intensities, frame rates, predefined numbers of frames, percentages, sums, averages and the like described herein have been provided for exemplary purposes and that various changes and alterations may be made thereto without departing from the scope of the present invention. For example, one of ordinary skill in the art will understand that the changes to the exemplary thresholds, energy levels, intensities, frame rates, predefined numbers of frames, percentages, sums, averages and the like may be made due to variations in camera quality, hardware, lighting conditions, subject matter, camera accuracy and the like.

The computerized system 10, shown in FIG. 1, and methods discussed herein advantageously enhance user interfaces for simple control, by providing a user input button through the camera lens 12, shown in FIG. 1, that may operate on any platform, without adding hardware or installing end-user software. In the computerized system 10, shown in FIG. 1, the user may simply block the camera lens 12, shown in FIG. 1, to signify a “button press” to trigger one or more events. Thus, the computerized system 10, shown in FIG. 1, provides a low cost, low power system and method of adding an intuitive user control to electronic devices.

Additionally, the computerized system 10, shown in FIG. 1, advantageously provides for the addition of user controls to the electronic device (e.g. a phone, tablet, laptop computer, personal computer or the like) without requiring platform-specific versions of software at the operating system or driver level, where code re-use is very low. Thus, the computerized system 10, shown in FIG. 1, provides a user input button solution that has very low complexity and is robust. This is unlike existing user input button solutions that are less intuitive and may require screen real estate for a virtual button, a physical button, or may require a user to search for, and then bring, a relevant application to the foreground on a screen.

Although this invention has been shown and described with respect to the detailed embodiments thereof, it will be understood by those skilled in the art that various changes in form and detail thereof may be made without departing from the spirit and the scope of the invention.

What is claimed is:

1. A system for providing an input button comprising:
a camera lens;
at least one processor connected to the camera lens, the at least one processor adapted to execute an imaging platform for detecting images through the camera lens; and
a trigger module in communication with the imaging platform and adapted to be executed by the at least one processor, the trigger module generating a trigger event upon a determination that at least one image frame captured through the camera lens is indicative of a button press;
wherein an application in communication with the trigger module performs an action in response to the trigger event.

2. The system according to claim 1, wherein the trigger module determines that at least one image frame is indicative of the button press if an average pixel intensity of a plurality of pixels of the image frame is below a threshold value.

3. The system according to claim 2, wherein the plurality of pixels is a subset of all of the pixels of the image frame.

4. The system according to claim 3, wherein the subset of pixels includes pixels dispersed along an edge of the image frame.

5. The system according to claim 1, wherein the trigger module analyzes a stream of image frames to determine if the stream of image frames is indicative of the button press and generates the trigger event upon a determination that the stream of image frames is indicative of the button press.

6. The system according to claim 5, wherein the trigger module compares an average pixel intensity of a plurality of pixels of each image frame of the stream of image frames to a threshold value and generates the trigger event if the average pixel intensity for each image frame is below the threshold value for a predefined number of consecutive image frames.

7. The system according to claim 5, wherein the trigger module is adapted to determine if consecutive image frames of the stream of image frames are getting progressively darker for a predefined number of image frames.

8. The system according to claim 1, wherein the trigger module is adapted to compute a sum or average of a number of pixels of the image frame with intensities that are below a first threshold and to compare the sum or average of the number of pixels to a second threshold;
wherein the trigger module generates the trigger event if the sum or average of the number of pixels exceeds the second threshold.

9. A computerized method comprising the steps of:
receiving, at a processor, at least one image frame captured through a camera lens;
analyzing, at the processor, the at least one image frame to determine if the at least one image frame is indicative of a button press;
generating a trigger event if the at least one image frame is indicative of the button press; and
performing an action through an application in response to the trigger event.

10. The method according to claim 9, wherein analyzing, at the processor, the at least one image frame includes comparing an average pixel intensity of a plurality of pixels of the image frame to a threshold value.

11. The method according to claim 10, wherein the trigger event is generated if the average pixel intensity is below the threshold value.

12. The method according to claim 10, wherein the plurality of pixels is a subset of all of the pixels of the image frame.

13. The method according to claim 12, wherein the subset includes pixels dispersed along an edge of the image frame.

14. The method according to claim 9, wherein analyzing, at the processor, the at least one image frame includes analyzing a stream of image frames to determine if the stream of image frames is indicative of the button press.

15. The method according to claim 14, wherein analyzing the stream of image frames includes comparing an average pixel intensity of a plurality of pixels of each image frame of the stream of image frames to a threshold value; and
wherein the trigger event is generated if the average pixel intensity for each image frame is below the threshold value for a predefined number of consecutive image frames.

16. The method according to claim 14, wherein analyzing the stream of image frames includes determining if the consecutive image frames of the stream of image frames are getting progressively darker for a predefined number of image frames.

17. The method according to claim 9, wherein analyzing, at the processor, the at least one image frame includes computing a sum or average of a number of pixels of the image frame with intensities that are below a first threshold and comparing the sum or average of the number of pixels to a second threshold; and
wherein the trigger event is generated if the sum or average of the number of pixels exceeds the second threshold.

18. A non-transitory, tangible computer-readable medium storing instructions adapted to be executed by at least one computer processor to perform a method comprising the steps of:
receiving, at the processor, at least one image frame captured through a camera lens;
analyzing, at the processor, the at least one image frame to determine if the at least one image frame is indicative of a button press;
generating a trigger event if the at least one image frame is indicative of the button press; and
performing an action through an application in response to the trigger event.

19. The non-transitory, tangible computer-readable medium of claim 18, wherein analyzing, at the processor, the at least one image frame includes comparing an average pixel intensity of a plurality of pixels of the image frame to a threshold value.

20. The non-transitory, tangible computer-readable medium of claim 19, wherein the trigger event is generated if the average pixel intensity is below the threshold value.

21. The non-transitory, tangible computer-readable medium of claim 19, wherein the plurality of pixels is a subset of all of the pixels of the image frame.

22. The non-transitory, tangible computer-readable medium of claim 21, wherein the subset includes pixels dispersed along an edge of the image frame.

23. The non-transitory, tangible computer-readable medium of claim 18, wherein analyzing, at the processor, the at least one image frame includes analyzing a stream of image frames to determine if the stream of image frames is indicative of the button press.

24. The non-transitory, tangible computer-readable medium of claim 23, wherein analyzing the stream of image frames includes comparing an average pixel intensity of a plurality of pixels of each image frame of the stream of image frames to a threshold value; and
wherein the trigger event is generated if the average pixel intensity for each image frame is below the threshold value for a predefined number of consecutive image frames.

25. The non-transitory, tangible computer-readable medium of claim 23, wherein analyzing the stream of image frames includes determining if the consecutive image frames of the stream of image frames are getting progressively darker for a predefined number of image frames.

26. The non-transitory, tangible computer-readable medium of claim 18, wherein analyzing, at the processor, the at least one image frame includes computing a sum or average of a number of pixels of the image frame with intensities that are below a first threshold and comparing the sum or average of the number of pixels to a second threshold; and
wherein the trigger event is generated if the sum or average of the number of pixels exceeds the second threshold.
